(19) United States
(12) Patent Application Publication
(10) Pub. No.: US 2003/0087176 A1
(43) Pub. Date: May 8, 2003

(54) Chemically prepared toners of controlled particle shape

(76) Inventors: Matthew C. Ezenyilimba, Walworth, NY (US); Hichang Yoon, Fairport, NY (US); John C. Wilson, Rochester, NY (US)

Correspondence Address: Christopher E. Blank, JAECKLE FLEISCHMANN & MUGEL, LLP, 39 State Street, Rochester, NY, 14614-1310, US

(21) Appl. No.: 10/187,561

(22) Filed: Jul. 2, 2002

Related U.S. Application Data
(60) Provisional application No. 60/307,776, filed on Jul. 25, 2001.

(51) Int. Cl. C08K 3/00

(52) U.S. Cl. 430/137.14; 523/339

(57) ABSTRACT

A process for preparing polymeric toner particles comprises dissolving a binder polymer in an organic solvent to form an organic phase, which is dispersed in an aqueous phase comprising a promoter and a particulate stabilizer to form a first dispersion. This first dispersion is homogenized to form a limited coalescence dispersion, to which is added poly(adipic acid-co-N-methylaminethanol), resulting in formation of a mixture comprising toner particle droplets. The organic solvent is removed from the mixture, and the resulting non-spherical toner particles are collected.

### CROSS-REFERENCE TO RELATED APPLICATION

In accordance with 37 CFR § 1.78(5), this application claims the benefit of copending provisional application Serial No. 60/307,776, filed Jul. 25, 2001, for CHEMICALLY PREPARED TONERS OF CONTROLLED PARTICLE SHAPE.

### FIELD OF THE INVENTION

This invention relates to a method for the preparation of polymeric powders suitable for use as electrostatographic toner, and more particularly, to a method for the preparation of toner particles of controlled shape in which copolymers of adipic acid and N-methylaminoethanol are employed for controlling shape of the particles.

### BACKGROUND OF THE INVENTION

Electrostatic toner polymer particles are commonly prepared by a process referred to as “limited coalescence”. In this process, polymer particles having a narrow size distribution are obtained by forming a solution of a polymer in a solvent that is immiscible with water, dispersing the solution so formed in an aqueous medium containing a solid colloidal stabilizer and removing the solvent by evaporation. The resultant particles are then isolated, washed and dried.

In the practice of this technique, toner particles are prepared from any type of polymer that is soluble in a water-immiscible solvent. Thus, the size and size distribution of the resulting particles can be predetermined and controlled by the relative quantities of the particular polymer employed, the solvent, the quantity and size of the water insoluble solid particulate suspension stabilizer, typically silica or latex, and the size to which the solvent-polymer droplets are reduced by mechanical shearing, using, for example, a rotor-stator type colloid mill or a high pressure homogenizer.

Limited coalescence techniques of this type have been described in numerous patents pertaining to the preparation of electrostatic toner particles because such techniques typically result in the formation of toner particles having a substantially uniform size distribution. Representative limited coalescence processes employed in toner preparation are described in U.S. Pat. Nos. 4,833,060 and 4,965,131, the disclosures of which are incorporated herein by reference.

The shape of the toner particles has a bearing on electrostatic toner transfer and cleaning properties. Thus, for example, the transfer and cleaning efficiency of toner particles have been found to improve as the sphericity of the particles is reduced. In order to enhance the cleaning and transfer properties of the toner, workers in the art have long sought to modify the shape of the evaporative limited coalescence type toners independently of pigment, binder, or charge agent choice.

U.S. Pat. No. 5,283,151 is representative of the prior art in this field and describes the use of carnauba wax to modify toner morphology. The method comprises the steps of dissolving carnauba wax in ethyl acetate heated to a temperature of at least 75° C. and cooling the solution, resulting in the precipitation of the wax in the form of very fine needles a few microns in length; recovering the wax needles and mixing them with a polymer material, a solvent, and, optionally, a pigment and/or a charge control agent, to form an organic phase; dispersing the organic phase in an aqueous phase comprising a particulate stabilizer and homogenizing the mixture; and evaporating the solvent and washing and drying the resultant product.

This technique, however, requires the use of elevated temperature to dissolve the wax in the solvent, followed by cooling the solution to precipitate the wax. The wax does not stay in solution in ethyl acetate at ambient temperature, which makes scale-up of this method very difficult.

### SUMMARY OF THE INVENTION

In accordance with the process of the present invention, poly(adipic acid-co-N-methylaminoethanol) is introduced into the aqueous phase of a limited coalescence process after droplets of an organic phase comprising an organic solvent and a dissolved binder polymer have been dispersed to predetermined and narrow size distributions in the aqueous phase. The use of this novel process results in the formation of non-spherical polymer particles whose shape is controlled independently of its composition and without affecting the particle size or size distribution determined by the dispersion conditions of the limited coalescence droplet formation.

Thus, the present invention is directed to a process for preparing polymeric toner particles that comprises dissolving a binder polymer in an organic solvent to form an organic phase, which is dispersed in an aqueous phase comprising a promoter and a particulate stabilizer to form a first dispersion. This first dispersion is homogenized to form a limited coalescence dispersion, to which is added poly(adipic acid-co-N-methylaminoethanol), resulting in formation of a mixture comprising toner particle droplets. The organic solvent is removed from the mixture, and the resulting non-spherical toner particles are collected.

It is an advantage of the process of the present invention that it is carried out under conditions that facilitate scale-up from laboratory flasks to large production equipment.

### DETAILED DESCRIPTION OF THE INVENTION

In accordance with the present invention, a binder polymer, an organic solvent and, optionally, a pigment and/or a charge control agent are combined to form an organic phase in which the binder polymer and optional pigment and charge control agent together comprise from about 1 to about 60, preferably about 10 to about 45, weight percent of the total organic phase.

A pigment, if present, comprises about 1 to about 40 weight percent, preferably about 4 to about 20 weight percent of total weight of pigment, charge control agent, and binder polymer. A pigment dispersion can be prepared by conventional techniques, for example, media milling, melt dispersion, and the like.

Suitable charge control agents are disclosed in, for example, U.S. Pat. Nos. 3,893,935, 4,323,634, and 4,079,014, and British Pat. No. 1,420,839, the disclosures of which are incorporated herein by reference. The charge control agent comprises from 0 to about 10 weight percent, preferably about 0.2 to about 3.0, weight percent of total weight of pigment, charge control agent, and binder polymer

The solvents chosen for use in the organic phase steps may be selected from among any of the well-known solvents capable of dissolving polymers. Typical of the solvents chosen for this purpose are dichloromethane, ethyl acetate, propyl acetate, methyl ethyl ketone and the like. Ethyl acetate and propyl acetate are preferred. The organic phase is stirred for a period of time, typically overnight, before being dispersed in an aqueous phase comprising a particulate stabilizer and, optionally, a promoter.

The particulate stabilizer selected for use in accordance with the present invention may be selected from among highly cross-linked polymeric latex materials of the type described in the previously mentioned U.S. Pat. No. 4,965,131, or from among inorganic oxides such as colloidal silica. A preferred stabilizer is colloidal silica, which is generally used in an amount ranging from about 1 part to about 15 parts per hundred of the total weight of solids in the organic phase. The size and concentration of these stabilizers control the size of the final toner particles, i.e., the smaller the size and/or the higher the concentration of such particles, the smaller the size of the final toner particles.

In order to drive the particulate stabilizer to the polymer/solvent droplet-water interface, a water-soluble promoter that affects the hydrophilic/hydrophobic balance of the stabilizer in the aqueous medium is employed. Typical suitable promoters are sulfonated polystyrenes, alginates, carboxymethyl cellulose, tetramethylammonium hydroxide or chloride, 2-diethylaminoethyl methacrylate, water-soluble amine-acid condensation products, water-soluble condensation products of ethylene oxide, urea and formaldehyde, polyethyleneimine, gelatin, casein, albumin, gluten, and methoxycellulose. A small amount of the poly(adipic acid-co-N-methylaminoethanol that is added to the polymeric particles following homogenization can also be employed as a promoter in the aqueous phase of the limited coalescence mixture during homogenization. The promoter is generally used in an amount from about 0.2 to about 0.6 parts per 100 parts by weight of the aqueous phase.

Various other additives frequently present in electrostatographic toners, for example, waxes and lubricants, may be added to the polymer prior to or during its dissolution in the solvent.

The organic-aqueous limited coalescence mixture is subjected to homogenization by mechanical shearing using, for example, a rotor-stator type colloid mill or a high-pressure homogenizer. In this process, the particulate stabilizer forms an interface between the organic globules in the organic phase, but, because of the high surface area associated with small particles, the coverage by the particulate stabilizer is not complete. After homogenization, coalescence continues until the surface is completely covered by particulate stabilizer. Thereafter, no further growth of the particles occurs. Accordingly, the amount of particulate stabilizer coverage is inversely proportional to the size of the toner obtained. The relationship between the aqueous phase and the organic phase may range from about 1:1 to about 9:1 by volume, i.e., the organic phase is typically present in an amount from about 10 to about 50 percent of the total homogenized volume.

Following the homogenization treatment, poly(adipic acid-co-N-methylaminoethanol) is added to the homogenized mixture in an amount equal to about 0.25 to about 50, preferably about 2 to about 20, weight percent of the pigment, charge control agent, and binder polymer taken together. Following the addition, the mixture is stirred for a period of time, typically overnight. The organic solvent is removed from the mixture by evaporation, vacuum boiling, and/or extraction, thereby producing highly non-spherical, irregularly shaped toner particles. While not wishing to be bound by any particular theory, we believe that, when the organic solvent is removed and the volume of the droplet decreases, the original droplet surface area is essentially preserved, resulting in a non-spherical shape.

A spherical particle is defined as a three-dimensional object having all points on its surface essentially equidistant from a central point. A non-spherical particle, on the other hand, is a three dimensional object in which individual points on the surface are at varying distances from a central point. Non-spherical particles are thus oblong or otherwise irregular in shape and may be characterized by wrinkled surfaces.

The present invention is applicable to the preparation of polymeric particles from any type of polymer that is capable of being dissolved in a water-immiscible solvent. Useful polymers include, for example, olefin homopolymers and copolymers such as polyethylene, polypropylene, polyisobutylene and polyisopentylene; polyfluoroolefins such as poly(tetrafluoroethylene) and poly(trifluorochlioroethylene); polyamides such as poly(hexamethylene adipamide), poly(hexamethylene sebacamide), and poly(caprolactam); acrylic resins such as poly(methyl methacrylate), poly(methyl acrylate), poly(ethyl methacrylate) and styrene-methyl methacrylate copolymers; ethylene-methyl acrylate copolymers, ethylene-ethyl acrylate copolymers, ethylene-ethyl methacrylate copolymers, polystyrene and copolymers of styrene with unsaturated monomers, cellulose derivatives, polyesters, polyvinyl resins and ethylene-allyl alcohol copolymers.

Pigments suitable for use in the practice of the present invention should be water-insoluble but dispersible in the polymer and should yield strong permanent color. Useful pigments include organic and orgonometallic pigments such as phthalocyanines, lithols, and the like and inorganic pigments such as titanium dioxide, carbon black, and the like. Typical phthalocyanine pigments are copper phthalocyanine, monochloro copper phthalocyanine, and hexadecachloro copper phthalocyanine. Other suitable organic pigments include vat pigments such as vat yellow 6GLCL1127, quinone yellow 18-1, indanthrone CL1106, pyranthrone CL1096, brominated pyranthrones such as dibromopyranthrone, vat brilliant orange RK, anthramide brown CL1151, dibenzanthrone green CL1101, flavanthrone yellow CL1118; azo pigments such as toluidine red C169 and hansa yellow; and metallized pigments such as azo yellow and permanent red. Carbon black may be any of the known types such as channel black, furnace black, acetylene black, thermal black, lamp black, and aniline black. The invention will be more fully understood by reference to the following illustrative examples, which are set forth solely for purposes of exposition and are not to be construed as limiting.

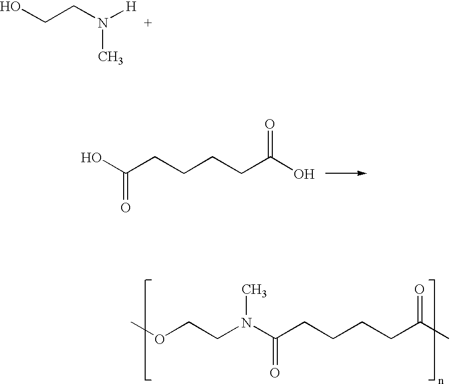

Standard Procedure for the Polymerization of Adipic Acid with N-Methylaminoethanol

To 1.048 kg adipic acid contained in a two-liter 3-necked flask provided with a condenser, was added, with stirring, 0.5392 kg of N-methylaminoethanol. The flask was placed into a hot oil bath, the contents were heated to 155° C. under nitrogen, and 80 ml of water distillate was collected and removed. The flask was sealed to prevent further water loss, then cooled. The inherent viscosity in methylene chloride of the polymeric product (0.25 g/100 ml solution) was measured at 25° C. and determined to be 0.020 dl/g.

Polymerization of Adipic Acid with N-methylaminoethanol at Varying Reaction Times

A mixture of 37.56 g (0.50 mol) of N-methylaminoethanol and 73.07 g (0.50 mol) of adipic acid was placed in a 3-necked 250-ml round-bottomed flask equipped with a nitrogen inlet, mechanical stirrer, and water-cooled take-off. The flask was immersed in an 80° C. oil bath and heated over a period of about 2 hrs to 180° C., while distilling off water generated in the condensation reaction. The flask was heated at 180° C. for a further reaction time of 1 hr, designated Procedure A, and cooled.

The just-described procedure was repeated, but with further reaction times of 2, 3, and 5 hours. These procedures were designated Procedures B, C, and D, respectively. The viscosities in methylene chloride solution and molecular weights were determined for the adipic acid-N-methylaminoethanol copolymers prepared by the standard procedure and by procedures A-D. The results of the viscosity measurements, along with the Mₙ, M_{w}, M_{w}/Mₙ, and M_{z} values determined for these polymers, are given in TABLE 1 below.

TABLE 1

| | | | | | Reaction | |
|---|---|---|---|---|---|---|
| Preparation | | | | | Time | Viscosity* |
| Procedure | M_{w} | Mₙ | M_{w}/Mₙ | M_{z} | (hr) | (dl/g CH₂Cl₂) |
| Standard | 669 | 538 | 1.24 | 773 | — | 0.020 |
| A | 751 | 498 | 1.51 | 1043 | 1 | 0.016 |
| B | 814 | 587 | 1.39 | 1027 | 2 | 0.028 |
| C | 812 | 593 | 1.32 | 1017 | 3 | 0.036 |
| D | 979 | 759 | 1.29 | 1161 | 5 | 0.044 |

*0.25g/100 ml solution at 25° C.

As expected, the viscosities of the copolymers are seen to increase with the increasing reaction times of Procedures A-D. A similar trend in molecular weights, in particular, the Mₙ values, is also observed.

### COMPARATIVE EXAMPLE 1

To 58.3 g of ethyl acetate was added 25.0 g of KAO C binder. This mixture, comprising the organic phase in an evaporative limited coalescence process, was mixed with an aqueous phase comprising 85 ml of pH4 buffer containing 13.0 g of NALCO® 1060 silica and 2.83 ml of a 10 weight percent aqueous solution of poly(adipic acid-co-N-methylaminoethanol) prepared by the standard procedure. The aqueous phase thus contained ˜0.28 g (1.13 wt. %) of the copolymer based on binder weight.

The resulting organic-aqueous mixture was subjected to very high shear using a POLYTRON® mixer, followed by treatment with a MICROFLUIDIZER® device. The organic solvent was removed from the particles so formed by stirring overnight at room temperature in an open container. The particles were washed with 0.1N potassium hydroxide solution to remove the silica, then with water, and dried. The toner particles were of about 3.58μ volume average diameter and substantially spherical, with a BET number of 0.96m²/g.

### COMPARATIVE EXAMPLE 2

To 58.3 g of ethyl acetate was added 25.0 g of KAO C binder. This mixture, comprising the organic phase in an evaporative limited coalescence process, was mixed with an aqueous phase comprising 85 ml of pH4 buffer containing 13.0 g of NALCO® 1060 silica and 31.13 ml of a 10 wt. % aqueous solution of poly(adipic acid-co-N-methylaminoethanol) prepared by the standard procedure. The aqueous phase thus contained ˜2.78 g (11.13 wt. %) of the copolymer based on binder weight.

The resulting organic-aqueous mixture was subjected to very high shear using a POLYTRON® mixer, followed by treatment with a MICROFLUIDIZER® device. The organic solvent was removed from the particles so formed by stirring overnight at room temperature in an open container. The particles were washed with 0.1N potassium hydroxide solution to remove the silica, then with water, and dried. The toner particles were of about 2.88μ volume average diameter and substantially spherical, with a BET number of 1.0 m²/g.

### EXAMPLE 1

To 58.3 g of ethyl acetate was added 25.0 g of KAO C binder polymer. This mixture, which comprised the organic phase in an evaporative limited coalescence process was mixed with an aqueous phase comprising 85 ml of pH4 buffer containing 13.0 g of NALCO® 1060 silica and 2.83 ml of a 10 wt. % aqueous solution of poly(adipic acid-co-N-methylaminoethanol) prepared by the standard procedure. The aqueous phase thus contained ˜0.28 g (1.13 wt. %) of the copolymer based on binder weight.

The resulting organic-aqueous mixture was then subjected to very high shear using a POLYTRON® mixer, followed by treatment with a MICROFLUIDIZER® device. Upon exiting, the homogenized mixture containing the polymeric particles was added into a solution in a small volume of water of 2.5 g of poly(adipic acid-co-N-methylaminoethanol), viscosity 0.020 dl/g, prepared by the standard procedure. The resulting mixture was stirred at room temperature overnight in an open container, during which time the organic solvent evaporated. The particles were collected, washed with 0.1N potassium hydroxide solution to remove the silica and then with water, and dried. The toner particles were of about 4.2μ volume average diameter and non-spherical, with a BET number of 1.14m²/g.

### EXAMPLE 2

The procedure of Example 1 was repeated with the exception that the 2.5 g of poly(adipic acid-co-N-methylaminoethanol), viscosity 0.020 dl/g, that was added to the homogenized mixture containing the polymeric particles was replaced by the same amount of poly(adipic acid-co-N-methylaminoethanol), viscosity 0.016 dl/g, prepared by procedure A. The resulting mixture was stirred at room temperature overnight in an open container, during which time the organic solvent evaporated. The particles were collected, washed with 0.1N potassium hydroxide solution to remove the silica and then with water, and dried. The toner particles were non-spherical and had a particle size of about 3.49μ, with a BET number of 1.35m²/g.

### EXAMPLE 3

The procedure of Example 1 was repeated with the exception that the 2.5 g of poly(adipic acid-co-N-methylaminoethanol, viscosity 0.020 dl/g, that was added to the homogenized mixture containing the polymeric particles was replaced by the same amount of poly(adipic acid-co-N-methylaminoethanol), viscosity 0.028 dl/g, prepared by procedure B. The resulting mixture was stirred at room temperature overnight in an open container, during which time the organic solvent evaporated. The particles were collected, washed with 0.1N potassium hydroxide solution to remove the silica and then with water, and dried. The toner particles were non-spherical and had a particle size of about 3.68μ, with a BET number of 1.74 m²/g.

### EXAMPLE 4

The procedure of Example 1 was repeated with the exception that the 2.5 g of poly(adipic acid-co-N-methylaminoethanol), viscosity 0.020 dl/g, that was added to the homogenized mixture containing the polymeric particles was replaced by the same amount of poly(adipic acid-co-N-methylaminoethanol), viscosity 0.036 dl/g, prepared by procedure C. The resulting mixture was stirred at room temperature overnight in an open container, during which time the organic solvent evaporated. The particles were collected, washed with 0.1N potassium hydroxide solution to remove the silica and then with water, and dried. The toner particles were non-spherical and had a particle size of about 3.45μ, with a BET number of 2.27m ²/g.

### EXAMPLE 5

The procedure of Example 1 was repeated with the exception that the 2.5 g of poly(adipic acid-co-N-methylaminoethanol), viscosity 0.020 dl/g, that was added to the homogenized mixture containing the polymeric particles was replaced by the same amount of poly(adipic acid-co-N-methylaminoethanol), viscosity 0.044 dl/g, prepared by procedure D. The resulting mixture was stirred at room temperature overnight in an open container, during which time the organic solvent evaporated. The particles were collected, washed with 0.1N potassium hydroxide solution to remove the silica and then with water, and dried. The toner particles were non-spherical and had a particle size of about 3.41μ, with a BET number of 2.62m²/g.

BET measurements were made using a SINGLE POINT MONOSORB® BET apparatus from Quantachrome Corporation. BET values were calculated as described in P. Chenebault and A. Schrenkamper, “The Measurement of Small Surface Areas by the B.E.T. Adsorption Method,” Journal of Physical Chemistry, Vol. 69, No. 7, July 1965, pages 2300-2305. A BET value of approximately 1.0 m²/g is indicative of a substantially spherical shape of the particles.

TABLE 2 below presents the results of BET measurements and volume average diameters of the toner particles produced by addition of adipic acid-N-methylaminoethanol copolymers of varying viscosities to the limited coalescence process reaction mixtures following homogenization. For illustrative Examples 1-5, a small amount, about 1.1 wt. % based on binder weight, of the adipic acid-N-methylaminoethanol copolymer prepared by the standard procedure was present as a promoter in the aqueous phase of the organic-aqueous mixture during the homogenization procedure, and 10 weight percent of the copolymer of varying viscosities, based on the weight of the binder polymer was added to the mixture after homogenization.

TABLE 2

| | Viscosity* | BET Value | Vol. avg. diameter |
|---|---|---|---|
| Example | (dl/g (CH₂Cl₂) | (m²/g) | (μ) |
| Comparative | | 0.96 | 3.58 |
| Example 1 | | | |
| Comparative | | 1.00 | 2.88 |
| Example 2 | | | |
| Example 1 | 0.020 | 1.14 | 4.2 |
| Example 2 | 0.016 | 1.35 | 3.49 |
| Example 3 | 0.028 | 1.74 | 3.68 |
| Example 4 | 0.036 | 2.27 | 3.45 |
| Example 5 | 0.044 | 2.62 | 3.41 |

*0.25g/100 ml solution at 25° C.

As shown by the results summarized in TABLE 2 above, inclusion of adipic acid-co-N-methylaminoethanol only in the aqueous phase, as in Comparative Examples 1 and 2, does not result in modification of the toner particle shape from a spherical shape. The BET values determined for Comparative Examples 1 and 2, where none of the copolymer was added post homogenization, are, respectively, 0.96 and 1.00 m²/g, indicating that the particles are substantially spherical in shape. The particle size, however, is affected by the concentration of the adipic acid-N-methylaminoethanol copolymer included in the aqueous phase, the higher concentration resulting in the formation of smaller particles.

In accordance with the process of the present invention, addition of adipic acid-co-N-methylaminoethanol after the homogenization step, followed by removal of the organic solvent, results in the formation of aspheric toner particles, with BET values substantially greater than 1. Furthermore, as shown by Examples 1-5, the degree of asphericity, as measured by BET values, of the polymeric toner particles can, surprisingly, be controlled by adding an adipic acid-N-methylaminoethanol copolymer of a selected viscosity following formation of the particles in the homogenization step. The higher the viscosity of the copolymer, the higher the BET value of the toner particles.

The invention has been described in detail with particular reference to certain preferred embodiments thereof, but it is to be understood that variations and modifications can be effected within the spirit and scope of the invention, which is defined by the following claims.

What is claimed is:

1. A process for preparing polymeric toner particles comprising:
dissolving a binder polymer in an organic solvent, thereby forming an organic phase;
dispersing said organic phase in an aqueous phase comprising a promoter and a particulate stabilizer, thereby forming a first dispersion;
homogenizing said first dispersion, thereby forming a limited coalescence dispersion;
adding poly(adipic acid-co-N-methylaminoethanol) to said limited coalescence dispersion, thereby forming a mixture comprising toner particle droplets;
removing said organic solvent from said mixture, thereby forming toner particles of non-spherical particle shape; and
collecting said toner particles.

2. The process of claim 1 further comprising:
washing said toner particles with an aqueous alkaline solution, thereby removing said particulate stabilizer from surface of said particles; and
drying said toner particles.

3. The process of claim 1 wherein said organic phase further includes a component selected from the group consisting of a pigment, a charge control agent, and combinations thereof.

4. The process of claim 3 wherein said pigment, said charge control agent, and said binder polymer together comprise about 1 to about 60 weight percent of said organic phase.

5. The process of claim 4 wherein said pigment, said charge control agent, and said binder polymer together comprise about 10 to about 45 weight percent of said organic phase.

6. The process of claim 3 wherein said pigment comprises about 1 to about 40 weight percent of said pigment, charge control agent, and binder polymer taken together.

7. The process of claim 6 wherein said pigment comprises about 4 to about 20 weight percent of said pigment, charge control agent, and binder polymer taken together.

8. The process of claim 3 wherein said charge control agent comprises from 0 to about 10 weight percent of said pigment, charge control agent, and binder polymer taken together.

9. The process of claim 8 wherein said charge control agent comprises about 0.2 to about 3.0 weight percent of said pigment, charge control agent, and binder polymer taken together.

10. The process of claim 1 wherein said organic solvent is selected from the group consisting of dichloromethane, ethyl acetate, propyl acetate, methyl ethyl ketone, and mixtures thereof.

11. The process of claim 10 wherein said organic solvent is ethyl acetate or propyl acetate.

12. The process of claim 1 wherein said particulate stabilizer comprises colloidal silica.

13. The process of claim 1 wherein said particulate stabilizer is present in an amount from about 1 part to about 15 parts by weight of the total weight of said pigment, charge control agent, and binder polymer in said organic phase.

14. The process of claim 1 wherein said promoter is selected from the group consisting of sulfonated polystyrenes, alginates, carboxymethylcellulose, methoxycellulose, tetramethylammonium hydroxide or chloride, 2-diethylaminoethyl methacrylate, gelatin, casein, albumin, gluten, water-soluble amine-acid condensation products, water-soluble condensation products of ethylene oxide, urea and formaldehyde, and polyethyleneimine.

15. The process of claim 14 wherein said promoter is poly(adipic acid-co-N-methylaminoethanol).

16. The process of claim 14 wherein said promoter is present in an amount about 0.2 to about 0.6 parts per 100 parts by weight of said aqueous phase.

17. The process of claim 1 wherein said binder polymer is selected from the group consisting of olefin homopolymers and copolymers, polyfluoroolefins, polyamides, acrylic and methacrylic polymers and copolymers, polystyrene and styrene copolymers, cellulose derivatives, polyesters, polyvinyl resins, and ethylene-allyl alcohol copolymers.

18. The process of claim 17 wherein said binder polymer is a polyester.

19. The process of claim 1 wherein said poly(adipic acid-co-N-methylaminoethanol) is added to said limited coalescence dispersion in an amount equal to about 0.25 to about 50 weight percent of said pigment, charge control agent, and binder polymer taken together.

20. The process of claim 19 wherein said poly(adipic acid-co-N-methylaminoethanol) is added in an amount equal to about 2 to about 20 weight percent of said pigment, charge control agent, and binder polymer taken together.

21. The process of claim 1 wherein said poly(adipic acid-co-N-methylaminoethanol) is characterized by a selected viscosity.

22. The process of claim 21 wherein said selected viscosity of said poly(adipic acid-co-N-methylaminoethanol) is at least about 0.01 dl/g, as measured for a solution of poly(adipic acid-co-N-methylaminoethanol) in methylene chloride at a concentration of 0.25 g per 100 ml of solution and a temperature of 25° C.
